(19) United States
(12) Patent Application Publication
(10) Pub. No.: US 2026/0026497 A1
(43) Pub. Date: Jan. 29, 2026

(54) SURFACE MODIFICATION OF BIODEGRADABLE POLYMERS AND USES THEREOF FOR RELEASE OF BIO-ACTIVE COMPOUNDS

(71) Applicants: GÉRALD CHOUINARD, SAINT-BRUNO-DE-MONTARVILLE (CA); THE ROYAL INSTITUTION FOR THE ADVANCEMENT OF LEARNING/MCGILL UNIVERSITY, MONTRÉAL (CA); POLYVALOR, LIMITED PARTNERSHIP, QUÉBEC (CA)

(72) Inventors: Darius KLASSEN, Montréal (CA); Jason Robert TAVARES, Longueuil (CA); Adya KARTHIKEYAN, Montréal (CA); Marie-Josée DUMONT, Lévis (CA); Gérald CHOUINARD, Saint-Bruno-de-Montarville (CA)

(73) Assignees: GÉRALD CHOUINARD, SAINT-BRUNO-DE-MONTARVILLE, QC (CA); THE ROYAL INSTITUTION FOR THE ADVANCEMENT OF LEARNING/MCGILL UNIVERSITY, MONTRÉAL, QC (CA); POLYVALOR, LIMITED PARTNERSHIP, QUÉBEC, QC (CA)

(21) Appl. No.: 18/995,772

(22) PCT Filed: Jul. 21, 2023
(86) PCT No.: PCT/CA2023/050982

§ 371 Date: Jan. 16, 2025

Related U.S. Application Data
(60) Provisional application No. 63/391,367, filed on Jul. 22, 2022.

(51) Int. Cl. A01N 25/10; A01N 25/18; A01N 25/34; A01N 27/00; A01N 31/06; A01P 17/00; A01P 19/00

(52) U.S. Cl. CPC A01N 25/10; A01N 25/18; A01N 25/34; A01N 27/00; A01N 31/06; A01P 17/00; A01P 19/00

(57) ABSTRACT

The present application relates to surface modification of polymers mesh, net or textile. More specifically, the present application relates to methods for modifying the surface of polymers and uses of the modified polymers for loading a bioactive compound. The present application includes use of the surface-modified polymers in agricultural applications, such as a pest control device or an exclusion net, for repelling, disrupting feeding, confusing or inhibiting the mating of, knocking down, sterilizing or killing a target pest species.

### CROSS-REFERENCE TO RELATED APPLICATIONS

The present application claims the benefit of priority of co-pending U.S. Provisional Patent Application No. 63/391,367, which was filed Jul. 22, 2022, the content of which is incorporated herein by reference in their entirety.

### FIELD

The present application is in the field of surface modification of polymers. More specifically, the present application relates to methods for modifying the surface of polymers mesh, net or textile and uses of the modified polymers for loading a bioactive compound.

### BACKGROUND

Pheromonal pest control is a targeted approach that uses a specie's own pheromone to repel insects, confuse them or disrupt mating behaviour. It is a well-established technique and known to be effective against both aphids and the oblique banded leafroller among other species (Cui et al. 2012; Nakashima et al. 2016). The main advantage of pheromonal pest control is that it is a more environmentally friendly form of pest control compared to conventional pesticides with fewer health risks (Blassioli-Moraes et al. 2019) Pheromonal pest control requires using dispensers to continuously administer pheromone to crops. These dispensers are normally small devices where pheromone is encapsulated in a membrane or solid matrix and gradually diffuses out of the dispenser into air (Tomaszewska et al. 2005).

However, pheromones degrade quickly and would not persist in fields if administered in large intermittent doses like pesticides (Tomaszewska et al. 2005). Pheromone dispensers come in many different forms and companies have continuously developed new designs to make them easier for farmers to distribute throughout a field or better at targeting multiple pest species simultaneously.

Another form of pests control that effectively protects crops from many pest species is physical exclusion, which uses a physical barrier like a net to keep pests off the plants. However, field studies such as those done on exclusion nets in Quebec apple orchards, have identified specific pest species that are not impeded by this physical barrier and flourish under the nets thanks to a lack of competition. For example, the study done in Quebec highlighted increased damage from aphids, which are small enough that it is impossible to produce a mesh with holes smaller than their body size without limiting airflow through the mesh (Mukherjee et al. 2019). The other problematic species identified was the oblique banded leafroller, which can live out its entire life cycle on a single plant and reproduces quickly under exclusion nets once established (Mukherjee et al. 2019). Due to these shortcomings, integrated strategies that combine physical exclusion with other approaches to overcome the limitations of individual pest control techniques are often recommended for providing more complete crop protection.

Since exclusion nets are ineffective against most pests with only a few exceptions, there is motivation to combine exclusion nets with a species-specific approach like pheromonal pest control. Furthermore, storing pheromone on surface structures would make it possible to combine the two approaches in a single device by using the nets themselves as a pheromone dispenser.

The idea of using a pheromone dispenser where the pheromone is desorbed from complex microstructures on the dispenser surface has not been explored before. All pheromone dispensers available commercially or mentioned in literature encapsulate the pheromone in a septum, in a membrane, in a solid matrix or, more rarely, use a canister of pheromone attached to an automated aerosol dispenser (Ioriatti and Lucchi 2016; Tomaszewska et al. 2005). Storing the pheromone on surface structures has the unique benefit of making it easier to reload the dispenser after all pheromone has been desorbed, since a new pheromone coating can just be applied directly to the surface.

By contrast, most commercial pheromone dispensers are single-use devices that cannot be reloaded with pheromone (Knight 2002). There is also ongoing research in the field of pheromonal pest control on how different pheromones affect different species and what mechanisms control the response in insects (Sullivan et al. 2015; Vosteen, Weisser, and Kunert 2016). Any bio-active compounds, such as pheromones that have already been well researched and shown to be effective against the target pests in long-term field studies, would potentially be suitable for such improved devices.

Discussions on integrated approaches combining pheromonal pest control and exclusion nets with other pest control strategies can be found in the literature. Some of these integrated approaches have been tested in field studies but there is no known field study specifically focusing on the combination of pheromonal pest control and exclusion netting (Lucchi et al. 2018; Mukherjee et al. 2019). Furthermore, turning an exclusion net into a pheromone dispenser to combine the two techniques in one device is not something that has been explored in the literature.

As such, there is need to provide improved methods and bioactive dispensers that at least alleviate some of the drawbacks of existing methods and devices. Specifically, pest control devices that can reloaded with bioactives, and reused repeatedly, to serve as an environmentally friendly and sustainable alternative to the use of harmful pesticides are highly desirable.

### SUMMARY

It has been surprisingly shown herein that methods of the present application provide for surface modification of polymers with improved properties. The methods of the present application further provide for loading of bioactive compounds of the modified-surface for improved release thereof, and polymers thus obtained. Comparable methods and polymers did not display the same properties, highlighting the surprising results obtained with the methods and polymers of the application.

Accordingly, the present application includes a method for modifying a wettability of a surface of a polymer mesh, net or textile, the method comprising:
subjecting the polymer mesh, net or textile to a treatment in a solvent; and
subjecting the resulting polymer to a treatment in a coagulant to provide the polymer with the surface having modified wettability.

The present application also includes a method for producing a modified-surface polymer mesh, net or textile, the method comprising:
subjecting a polymer mesh, net or textile to a treatment in a solvent; and
subjecting the resulting polymer to a treatment in a coagulant to provide the modified-surface polymer.

The present application also includes a method for producing a modified-surface polymer mesh, net or textile loaded with a bioactive compound, the method comprising:
subjecting a polymer mesh, net or textile to a treatment in a solvent;
subjecting the resulting polymer to a treatment in a coagulant to provide the modified-surface polymer mesh, net or textile; and
loading the bioactive on the modified-surface polymer by physisorption.

The present application further includes a method for producing a semiochemical pest control device, the method comprising:
subjecting a polymer mesh, net or textile to a treatment in a solvent;
subjecting the resulting polymer to a treatment in a coagulant to provide the modified-surface polymer; and
loading at least one insect semiochemical on the modified-surface polymer mesh, net or textile by physisorption to provide the semiochemical pest control device.

Also included is a method for producing an exclusion net for use in agriculture, the method comprising:
subjecting a mesh polymer to a treatment in a solvent;
subjecting the resulting polymer to a treatment in a coagulant to provide the modified-surface polymer; and
loading at least one insect semiochemical on the modified-surface mesh polymer by physisorption to provide the exclusion net.

Further included is a method for repelling, disrupting feeding, confusing or inhibiting mating of, knocking down, sterilizing or killing a target pest species, the method comprising;
producing an exclusion net by
subjecting a mesh polymer to a treatment in a solvent;
subjecting the resulting polymer to a treatment in a coagulant to provide the modified-surface polymer; and
loading at least one semiochemical of the target pest species on the modified-surface mesh polymer by physisorption to provide the exclusion net;
placing the exclusion net in the target pest species environment.

The present application also includes a method for protecting a crop from target pest species, the method comprising;
producing an exclusion net by
subjecting a mesh polymer to a treatment in a solvent;
subjecting the resulting polymer to a treatment in a coagulant to provide the modified-surface polymer; and
loading at least one semiochemical of the target pest species on the modified-surface mesh polymer by physisorption to provide the exclusion net;
placing the exclusion net on the crop to protect said crop from the target pest species.

In some embodiments, the polymer is an amorphous polymer or a surface-amorphous polymer. In some embodiments, the polymer is a semi-crystalline polymer or a crystalline polymer. In some embodiments, the polymer is an amorphous polymer, a surface-amorphous polymer, a semi-crystalline polymer, a crystalline polymer, or co-polymers and combinations thereof. In some embodiments, the polymer is a polymeric mesh. In some embodiments, the polymer is selected from a polylactic acid polymer, nylon, a polycarbonate polymer, a polyethylene polymer, and mixtures thereof. In some embodiments, it will be appreciated that the term “polymeric mesh” includes a mesh, net or textile or filaments, threads, yarns or any material used to constitute the mesh, net or textile and this will be within the purview of the person skilled in the art.

In some embodiments, the solvent is selected from acetone, ethyl acetate, ethanol, acetonitrile, ionic liquids and mixtures thereof. In some embodiments, the solvent is a solvent with a Relative Energy Distance (RED) between about 0.4 and about 1.0 (determine through Hansen solubility parameters).

In some embodiments, the coagulant is selected from water, methanol, ethanol, ethylene glycol and mixtures thereof.

In some embodiments, the treatment in the solvent comprises dipping in the solvent for about 0.5 second to about 30 minutes. In some embodiments, the treatment in the solvent comprises dipping in the solvent for about 5 seconds to about 20 minutes. In some embodiments, the treatment in the solvent comprises dipping in the solvent for about 10 seconds to about 10 minutes.

In some embodiments, the treatment in the coagulant comprises dipping in the solvent for about 0.5 second to about 30 minutes. In some embodiments, the treatment in the coagulant comprises dipping in the solvent for about 5 seconds to about 20 minutes. In some embodiments, the treatment in the coagulant comprises dipping for 10 seconds to about 10 minutes.

In some embodiments, the method further comprises a pre-heating treatment in a heated liquid media. In some embodiments, the liquid media is heated at a temperature of about 30° C. to about 150° C. above the glass transition temperature of the polymer. In some embodiments, the liquid media is heated at a temperature of about 35° C. to about 125° C. above the glass transition temperature of the polymer. In some embodiments, the liquid media is heated at a temperature of about 40° C. to about 100° C. above the glass transition temperature of the polymer.

In some embodiments, the pre-heating treatment comprises dipping in the heated liquid media for about 0.2 second to about 10 minutes. In some embodiments, the pre-heating treatment comprises dipping in the heated liquid media for about 0.3 seconds to about 1 minute. In some embodiments, the pre-heating treatment comprises dipping in the heated liquid media for about 0.5 seconds to about 10 seconds.

In some embodiments, the liquid media is selected from ethylene glycol, acetone, mineral oil, vegetable oil, a solvent having a boiling point about 40° C. to about 100° C. above the glass transition temperature of the polymer and mixtures thereof.

In some embodiments, the bioactive is insect semiochemicals or analogues thereof, repellents, and mixtures thereof. In some embodiments, the repellent is selected from limonene, carvone, myrcene and combinations thereof. In some embodiments, the semiochemicals are intraspecific or interspecific semiochemicals. In some embodiments, the intraspecific semiochemicals are pheromones. In some embodiments, the interspecific semiochemicals are selected from allomones, kairomones, synomones, antimones, necromones, and mixtures thereof. In some embodiments, the pheromone is E-beta-farnesene (EBF).

In some embodiments, the surface is modified to increase hydrophobicity. In some embodiments, the hydrophobicity is increased to provide a water contact angle of about 90° to about 180°. In some embodiments, the hydrophobicity is increased to provide a water contact angle of about 100° to about 180°. In some embodiments, the hydrophobicity is increased to provide a water contact angle of about 120° to about 180°.

In some embodiments, the bioactive compound and/or semiochemical is released from the modified-surface polymer over about 10 days to about 90 days. In some embodiments, the bioactive compound and/or semiochemical is released from the modified-surface polymer over about 20 days to about 80 days. In some embodiments, the bioactive compound and/or semiochemical is released from the modified-surface polymer over about 30 days to about 70 days.

In some embodiments, the bioactive compound and/or semiochemical is released from the modified-surface polymer at a release rate from about 5 mg/m² per day to about 500 mg/m² per day. In some embodiments, the bioactive compound and/or semiochemical is released from the modified-surface polymer at a release rate from about 20 mg/m² per day to about 400 mg/m² per day. In some embodiments, the bioactive compound and/or semiochemical is released from the modified-surface polymer at a release rate from about 40 mg/m² per day to about 200 mg/m² per day.

In some embodiments, loading of an additional bioactive and/or semiochemical is repeated upon release of the originally loaded bioactive and/or semiochemical.

In some embodiments, the loading of the bioactive and/or semichemical further comprises an antioxidant and/or a polymerization inhibitor. In some embodiments, the antioxidant and/or a polymerization inhibitor is mixed with the bioactive and/or semiochemical in solution before loading. In some embodiments, the antioxidant and/or a polymerization inhibitor is in an amount of about 2 g/L to about 50 g/L relative to the solution of bioactive and/or semiochemical. In some embodiments, the antioxidant and/or a polymerization inhibitor is in an amount of about 3 g/L to about 45 g/L relative to the solution of bioactive and/or semiochemical. In some embodiments, the antioxidant and/or a polymerization inhibitor is in an amount of about 4 g/L to about 40 g/L relative to the solution of bioactive and/or semiochemical. In some embodiments, the antioxidant is diphenylamine (DPA). In some embodiments, the antioxidant is propyl gallate or tocopherol. In some embodiments, the antioxidant is diphenylamine, propyl gallate, tocopherol or combinations thereof.

In some embodiments, the loading of the bioactive and/or semichemical further comprises an UV blocker. In some embodiments, the UV blocker is mixed with the bioactive and/or semiochemical in solution before loading. In some embodiments, the UV blocker is in an amount of about 2 g/L to about 50 g/L relative to the solution of bioactive and/or semiochemical. In some embodiments, the UV blocker is in an amount of about 3 g/L to about 45 g/L relative to the solution of bioactive and/or semiochemical. In some embodiments, the UV blocker is in an amount of about 4 g/L to about 40 g/L relative to the solution of bioactive and/or semiochemical. In some embodiments, the UV blocker is benzophenone, benzotriazole, or derivatives thereof.

In some embodiments, the loading of the bioactive and/or semichemical further comprises an antioxidant, a polymerization inhibitor, an UV blocker or combinations thereof.

The present application also includes a polylactic acid mesh polymer having a hydrophobic modified-surface.

Also provided is a polylactic acid mesh polymer produced by the method of the present application.

In some embodiments, the polylactic acid mesh polymer has the above-mentioned properties.

The present application also includes a bioactive compound loaded on a modified-surface polymer mesh, net or textile.

Further included is a bioactive compound loaded on a modified-surface polymer mesh, net or textile produced by the method of the present application.

In some embodiments, the bioactive compound is for use as a semiochemical pest control device. In some embodiments, the bioactive compound is for use as an exclusion net. In some embodiments, the bioactive compound is for use in agricultural applications. In some embodiments, the bioactive compound is for repelling, disrupting feeding, confusing or inhibiting the mating of, knocking down, sterilizing or killing a target pest species.

In some embodiments, the bioactive compound loaded on a modified surface polymer mesh, net or textile has the above-mentioned properties.

The present application also includes a semiochemcial pest control device comprising at least one semiochemical loaded on a modified-surface polymer mesh, net or textile.

Also provided is a semiochemcial pest control device produced by a method of the present application.

In some embodiments, the device is for use as an exclusion net. In some embodiments, the device is for use in agricultural applications. In some embodiments, the device is for repelling, disrupting feeding, confusing or inhibiting the mating of, knocking down, sterilizing or killing a target pest species.

In some embodiments, the device has the above-mentioned properties.

The present application also includes an exclusion net for agricultural use comprising at least one semiochemical loaded a modified-surface mesh polymer.

Further included is an exclusion net for agricultural use prepared by a method of the present application.

In some embodiments, the exclusion net is for use as a semiochemical pest control device for repelling, disrupting feeding, confusing or inhibiting the mating of, knocking down, sterilizing or killing a target pest species.

In some embodiments, the exclusion net has the above-mentioned properties.

Also included is a use of a modified-surface polymer mesh, net or textile produced by a method of the present application, in agricultural applications.

Use of a modified-surface polymer mesh, net or textile produced by a method of the present application, as a pheromonal pest control device.

Also provided is a use of a modified-surface polymer mesh, net or textile produced by a method of the present application, as an exclusion net.

Further included is a use of a modified-surface polymer mesh, net or textile produced by a method of the present application, for repelling, disrupting feeding, confusing or inhibiting the mating of, knocking down, sterilizing or killing a target pest species.

Also included is a use of a polylactic acid mesh polymer having a modified-surface, a bioactive compound loaded on a modified-surface polymer, a semiochemical pest control device or an exclusion net of the present application, in agricultural applications.

Further included is a use of a polylactic acid mesh polymer having a modified-surface 1, a bioactive compound loaded on a modified-surface polymer, or an exclusion net of the present application, as a semiochemical pest control device

Further provided is a use of a polylactic acid mesh polymer having a modified-surface, a bioactive compound loaded on a modified-surface polymer, or a semiochemical pest control device of the present application as an exclusion net.

Also included is a use of a polylactic acid mesh polymer having a modified-surface of, a bioactive compound loaded on a modified-surface polymer, a semiochemical pest control device or an exclusion net of the present application, for repelling, disrupting feeding, confusing or inhibiting the mating of, knocking down, sterilizing or killing a target pest species.

The present application also includes a kit for preparing a modified-surface polymer mesh, net or textile, the kit comprising:
optionally the polymer mesh, net or textile;
a first treatment solution comprising a solvent; and
a second treatment solution comprising a coagulant.

The present application further includes a kit for preparing a modified-surface polymer filaments, threads or yarns, the kit comprising:
optionally the filaments, threads, yarns and combinations thereof;
a first treatment solution comprising a solvent; and
a second treatment solution comprising a coagulant.

The present application also includes a method for modifying a wettability of a surface of a filaments, threads or yarns, the method comprising: subjecting the polymer filaments, threads or yarns to a treatment in a solvent; and subjecting the resulting polymer to a treatment in a coagulant to provide the polymer with the surface having modified wettability.

Further provided is a method for producing a modified-surface polymer filaments, threads or yarns, the method comprising: subjecting a polymer filaments, threads or yarns to a treatment in a solvent; and subjecting the resulting polymer to a treatment in a coagulant to provide the modified-surface polymer.

The present application further includes a method for producing a modified-surface polymer filaments, threads or yarns loaded with a bioactive compound, the method comprising: subjecting a polymer filaments, threads or yarns to a treatment in a solvent; subjecting the resulting polymer to a treatment in a coagulant to provide the modified-surface polymer filaments, threads or yarns; and loading the bioactive on the modified-surface polymer by physisorption.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows a graph of mass retention as a function of time from limonene mass loss tests on modified PLA meshes, according to exemplary embodiment of the application.

FIG. 2 shows an image of a mesh on a holder for water drop test, according to exemplary embodiment of the application.

FIG. 3 shows SEM micrographs showing surface morphology for (a) untreated mesh; (b) standard treatment; (c) with heating treatment in acetone; and (d) with pre-heating treatment in ethylene glycol followed by standard treatment, according to exemplary embodiments of the application.

FIG. 4 shows a Fourier transform infrared spectrographs of different surface-modified meshes compared to untreated mesh, according to exemplary embodiments of the application.

FIG. 5 shows mechanical strength of different surface-modified meshes compared to untreated mesh, according to exemplary embodiments of the application.

FIG. 6 shows an XRD graph of a commercially available mesh compared to lab scale printed PLA according to exemplary embodiment of the application.

FIG. 7 shows an XRD graph of different surface-modified meshes compared to untreated mesh, according to exemplary embodiments of the application.

FIG. 8 shows melting curves of heat flow as a function of temperature from differential scanning calorimetry of different surface-modified meshes compared to untreated mesh, according to exemplary embodiments of the application.

FIG. 9 shows wettability from water drop test on different surface-modified meshes compared to untreated mesh, according to exemplary embodiments of the application.

FIG. 10 shows a graph of mass loss as a function of time from E-beta-farnesene on modified nets, according to exemplary embodiment of the application.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “device of the application” or “composition of the present application” and the like as used herein refers to a composition comprising one or more polymer of the application.

The term “suitable” as used herein means that the selection of the particular composition or conditions would depend on the specific steps to be performed, the identity of the components to be transformed and/or the specific use for the compositions, but the selection would be well within the skill of a person trained in the art.

As used herein, the term “effective amount” means an amount of a bioactive compound, or one or more bioactive compounds, that is effective, at dosages and for periods of time necessary to achieve the desired result.

The present description refers to a number of chemical terms and abbreviations used by those skilled in the art. Nevertheless, definitions of selected terms are provided for clarity and consistency.

The term “aq.” as used herein refers to aqueous.

The term “SEM” as used herein refers to scanning electron microscopy.

The term “XRD” as used herein refers to X-ray diffraction.

The term “DSC” as used herein refers to differential scanning calorimetry.

The terms “PLA” as used herein refers to polylactic acid.

The term “pest” as used herein refers to a destructive insect or other animal that is harmful or damaging to crops, food, livestock, forestry, etc.

The term “bioactive” as used herein generally refers to a compound that has an effect on a living organism, tissue or cell.

The term “semiochemicals” as used herein refers to a substance or mixture of substances released by an organism to signal other organisms and provoke a behavioural or physiological response. Semiochemicals can be intraspecific or interspecific. For example, pheromones are intraspecific semiochemicals used for signaling between members of the same species. Interspecific semiochemicals are used for signaling between members of different species and include allomones, kairomones, synomones, antimones and necromones. In the context of the present application, the semiochemicals used can be obtained synthetically.

The term “pheromones” means a substance or mixture of substances released by an organism used for signaling between members of the same species.

The term “biodegradable” as used herein, or compostable, refers to the ability of a material/substance to be disintegrated/decomposed, for example by the action of microorganisms such as bacteria or fungi biological with or without oxygen, and/or by the effect of hydrolysis and/or UV radiation.

### II. Compositions of the Application and Methods for Producing the Same

It has been surprisingly shown herein that methods of the present application provide for surface modification of polymers mesh, net or textile with improved properties. The methods of the present application further provide for loading of bioactive compounds of the modified-surface for improved release thereof, and polymers thus obtained. Comparable methods and polymers did not display the same properties, highlighting the surprising results obtained with the methods and polymers of the application.

Accordingly, the present application includes a method for modifying a wettability of a surface of a polymer mesh, net or textile, the method comprising: subjecting the polymer mesh, net or textile to a treatment in a solvent; and subjecting the resulting polymer to a treatment in a coagulant to provide the polymer mesh, net or textile with the surface having modified wettability.

The present application also includes a method for producing a modified-surface polymer mesh, net or textile, the method comprising: subjecting a polymer mesh, net or textile to a treatment in a solvent; and subjecting the resulting polymer to a treatment in a coagulant to provide the modified-surface polymer mesh, net or textile.

The present application further includes a method for producing a modified-surface polymer mesh, net or textile loaded with a bioactive compound, the method comprising: subjecting a polymer mesh, net or textile to a treatment in a solvent; subjecting the resulting polymer to a treatment in a coagulant to provide the modified-surface polymer mesh, net or textile; and loading the bioactive on the modified-surface polymer by physisorption.

Further included is a method for producing a semiochemical pest control device, the method comprising: subjecting a polymer mesh, net or textile to a treatment in a solvent; subjecting the resulting polymer to a treatment in a coagulant to provide the modified-surface polymer mesh, net or textile; and loading at least one insect semiochemical on the modified-surface polymer by physisorption to provide the semiochemical pest control device.

Also provided is a method for producing an exclusion net for use in agriculture, the method comprising: subjecting a mesh polymer to a treatment in a solvent; subjecting the resulting polymer to a treatment in a coagulant to provide the modified-surface polymer; and loading at least one insect semiochemical on the modified-surface mesh polymer by physisorption to provide the exclusion net.

The present application also includes a method for repelling, disrupting feeding, confusing or inhibiting mating of, knocking down, sterilizing or killing a target pest species, the method comprising; producing an exclusion net by subjecting a mesh polymer to a treatment in a solvent; subjecting the resulting polymer to a treatment in a coagulant to provide the modified-surface polymer; and loading at least one semiochemical of the target pest species on the modified-surface mesh polymer by physisorption to provide the exclusion net; placing the exclusion net in an environment of the target pest species.

The present application also provides a method for protecting a crop from target pest species, the method comprising; producing an exclusion net by subjecting a mesh polymer to a treatment in a solvent; subjecting the resulting polymer to a treatment in a coagulant to provide the modified-surface polymer; and loading at least one semiochemical of the target pest species on the modified-surface mesh polymer by physisorption to provide the exclusion net; placing the exclusion net on the crop to protect said crop from the target pest species.

The polymers made by the methods of the application may thus be used in pest control for crop protection. It can be used for any crop, provided, appropriate bio-active compounds are selected for impregnation on the modified polymer surface. The intent is to impregnate the polymer with bioactive compounds in the form of semiochemicals, such as pheromones, to create dispensers that are then placed throughout a field to provide protection from all potential pests for a period of weeks or months as the bioactive compounds slowly desorb. The dispensers can then be taken down and reloaded with bioactives or reloaded directly on-site, and reused repeatedly. These dispensers can also take the form of exclusion nets that provide the additional benefit of acting as a physical barrier against pests. As such, the polymers of the application may serve as an environmentally friendly and sustainable alternative to the use of harmful pesticides.

Surface modification of polymers to create complex microstructures and increase surface area can be accomplished by a variety of techniques. One of the simpler techniques used for this purpose is solvent induced crystallization, such as a technique designated as Dip-Dip-Dry (DDD), which can be used for surface modification of polylactic acid (PLA) (Knoch et al., 2019, 2020). Without being bound to theory, the DDD technique creates complex porous microstructures on the PLA surface that were demonstrated to allow for adsorption and slow release of the bioactive compound limonene (Knoch et al., 2020). Based on previous work done with the DDD technique, the crucial change of using semiochemicals instead of limonene was made. Semiochemicals, such as pheromones, are bioactive compounds like limonene which can be used to effectively control insect pests at much lower concentrations and are species specific (Vandermoten et al., 2012).

Hence, the DDD technique was used to create polymer surfaces that could be impregnated with semiochemicals for the purpose of using semiochemical pest control to protect crops from insect pests.

In some embodiments, the polymer mesh, net or textile is an amorphous polymer or a surface-amorphous polymer. In some embodiments, the polymer is a semi-crystalline polymer or a crystalline polymer. In some embodiments, the polymer is an amorphous polymer, a surface-amorphous polymer, a semi-crystalline polymer, a crystalline polymer, or co-polymers and combinations thereof. In some embodiments, the polymer is a polymeric mesh. In some embodiments, the polymer is selected from a polylactic acid polymer, nylon, a polycarbonate polymer, a polyethylene polymer, and mixtures thereof. In some embodiments, it will be appreciated that the term “polymeric mesh” includes a mesh, net or textile or filaments, threads, yarns or any material used to constitute the mesh, net or textile. In some embodiments, the methods of the present application can be conducted on filaments, threads or yarns which can be assembled into mesh, net or textile.

In some embodiments, the solvent is selected from acetone, ethyl acetate, ethanol, acetonitrile, ionic liquids and mixtures thereof. In some embodiments, the ionic liquid is selected from salts of 1-ethyl-3-methyl-imidazolium (EMIM), 1-butyl-3-methyl-imidazolium (BMIM), 1-octyl-3-methyl-imidazolium (OMIM), 1-decyl-3-methyl-imidazolium (DMIM), 1-dodecyl-3-methyl-docecyl-imidazolium (DMDIM), 1-butyl-2,3-dimethylimidazolium (BMMIM or DBMIM), 1,3-di(N,N-dimethylaminoethyl)-2-methylimidazolium (DAMI), 4-methyl-N-butyl-pyridinium (MBPy), N-octylpyridinium (C8Py), tetraethylammonium (TEA), tetrabutylammonium (TBA). Trihexyl(tetradecyl)phosphonium (P6,6,6,14) and tributyl(tetradecyl)phosphonium (P4,4,4,14), in which the anion is selected from chlorate, bromate, acetate, tetrafluoroborate (BF₄), hexafluorophosphate (PF₆), bis-trifluoromethanesulfonimide (NTf₂), trifluoromethanesulfonate (OTf), dicyanamide (N(CN)₂), hydrogen sulphate (HSO₄), ethyl sulphate (EtOSO₃) and tetrachloroferrate. In some embodiments, the solvent is a solvent with a Relative Energy Distance (RED) between about 0.4 and about 1.0 (determine through Hansen solubility parameters).

In some embodiments, the coagulant is selected from water, methanol, ethanol, ethylene glycol and mixtures thereof.

In some embodiments, the treatment in the solvent comprises dipping in the solvent for about 0.5 second to about 30 minutes. In some embodiments, the treatment in the solvent comprises dipping in the solvent for about 5 seconds to about 20 minutes. In some embodiments, the treatment in the solvent comprises dipping in the solvent for about 10 seconds to about 10 minutes.

In some embodiments, the treatment in the coagulant comprises dipping in the solvent for about 0.5 second to about 30 minutes. In some embodiments, the treatment in the coagulant comprises dipping in the solvent for about 5 seconds to about 20 minutes. In some embodiments, the treatment in the coagulant comprises dipping for 10 seconds to about 10 minutes.

In some embodiments, the method of the application further comprises a pre-heating treatment in a heated liquid media. In some embodiments, the liquid media is heated at a temperature of about 30° C. to about 150° C. above the glass transition temperature of the polymer. In some embodiments, the liquid media is heated at a temperature of about 35° C. to about 125° C. above the glass transition temperature of the polymer. In some embodiments, the liquid media is heated at a temperature of about 40° C. to about 100° C. above the glass transition temperature of the polymer. In some embodiments, the pre-heating treatment comprises dipping in the heated liquid media for about 0.2 second to about 10 minutes. In some embodiments, the pre-heating treatment comprises dipping in the heated liquid media for about 0.3 seconds to about 1 minute. In some embodiments, the pre-heating treatment comprises dipping in the heated liquid media for about 0.5 seconds to about 10 seconds. In some embodiments, the liquid media is selected from ethylene glycol, acetone, mineral oil, vegetable oil, a solvent having a boiling point about 40° C. to about 100° C. above the glass transition temperature of the polymer and mixtures thereof.

In some embodiments, the bioactive is insect semiochemicals or analogues thereof, repellents, and mixtures thereof. In some embodiments, the repellent is selected from limonene, carvone, myrcene and combinations thereof. In some embodiments, the repellent is limonene. In some embodiments, the semiochemicals are intraspecific or interspecific semiochemicals. In some embodiments, the intraspecific semiochemicals are pheromones. In some embodiments, the interspecific semiochemicals are selected from allomones, kairomones, synomones, antimones, necromones, and mixtures thereof. In some embodiments, the pheromone is E-beta-farnesene (EBF). In some embodiments, the bioactive is a synthetic semiochemical or analogues thereof.

In some embodiments, the surface is modified to increase hydrophobicity. In some embodiments, the hydrophobicity is increased to provide a water contact angle of about 90° to about 180°. In some embodiments, the hydrophobicity is increased to provide a water contact angle of about 100° to about 180°. In some embodiments, the hydrophobicity is increased to provide a water contact angle of about 120° to about 180°.

In some embodiments, the bioactive compound and/or semiochemical is released from the modified-surface polymer over about 10 days to about 90 days. In some embodiments, the bioactive compound and/or semiochemical is released from the modified-surface polymer over about 20 days to about 80 days. In some embodiments, the bioactive compound and/or semiochemical is released from the modified-surface polymer over about 30 days to about 70 days.

In some embodiments, the bioactive compound and/or semiochemical is released from the modified-surface polymer at a release rate from about 5 mg/m² per day to about 500 mg/m² per day. In some embodiments, the bioactive compound and/or semiochemical is released from the modified-surface polymer at a release rate from about 20 mg/m² per day to about 400 mg/m² per day. In some embodiments, the bioactive compound and/or semiochemical is released from the modified-surface polymer at a release rate from about 40 mg/m² per day to about 200 mg/m² per day.

In some embodiments, loading of an additional bioactive and/or semiochemical is repeated upon release of the originally loaded bioactive and/or semiochemical. In some embodiments, the additional bioactive and/or semiochemical is the same or different from the originally loaded bioactive.

In some embodiments, the loading of the bioactive further comprises an antioxidant and/or a polymerization inhibitor. In some embodiments, the antioxidant and/or a polymerization inhibitor is mixed with the bioactive and/or semiochemical in solution before loading. In some embodiments, the antioxidant and/or a polymerization inhibitor is in an amount of about 2 g/L to about 50 g/L relative to the solution of bioactive and/or semiochemical. In some embodiments, the antioxidant and/or a polymerization inhibitor is in an amount of about 3 g/L to about 45 g/L relative to the solution of bioactive and/or semiochemical. In some embodiments, the antioxidant and/or a polymerization inhibitor is in an amount of about 4 g/L to about 40 g/L relative to the solution of bioactive and/or semiochemical. In some embodiments, the antioxidant is diphenylamine (DPA). In some embodiments, the antioxidant is propyl gallate or tocopherol. In some embodiments, the antioxidant is diphenylamine, propyl gallate, tocopherol or combinations thereof.

In some embodiments, the loading of the bioactive and/or semichemical further comprises an UV blocker. In some embodiments, the UV blocker is mixed with the bioactive and/or semiochemical in solution before loading. In some embodiments, the UV blocker is in an amount of about 2 g/L to about 50 g/L relative to the solution of bioactive and/or semiochemical. In some embodiments, the UV blocker is in an amount of about 3 g/L to about 45 g/L relative to the solution of bioactive and/or semiochemical. In some embodiments, the UV blocker is in an amount of about 4 g/L to about 40 g/L relative to the solution of bioactive and/or semiochemical. In some embodiments, the UV blocker is benzo phenome, benzotriazoles, or derivatives thereof.

In some embodiments, the loading of the bioactive and/or semichemical further comprises an antioxidant, a polymerization inhibitor, an UV blocker or combinations thereof.

The application further provides a polylactic acid mesh polymer having a hydrophobic modified-surface.

Also included is a polylactic acid mesh polymer obtained by the method of the application.

The application further includes a bioactive compound loaded on a modified-surface polymer.

Also included is a bioactive compound loaded on a modified-surface polymer obtained by the method of the application.

The application further provides a semiochemical pest control device comprising at least one semiochemical loaded on a modified-surface polymer.

Also included is a semiochemical pest control device produced by a method of the present application.

The application provides an exclusion net for agricultural use comprising at least one semiochemical loaded a modified-surface mesh polymer.

Further provided is an exclusion net for agricultural use prepared by a method of the application.

In some embodiments, the polylactic acid mesh polymer, the bioactive compound loaded on a modified-surface polymer, the semiochemical pest control device and the exclusion net have the properties have previously defined.

The present application further includes a kit for preparing a modified-surface mesh polymer, the kit comprising:
optionally the mesh polymer;
a first treatment solution comprising a solvent; and
a second treatment solution comprising a coagulant.

### III. Uses of the Application

The methods of the application have been shown to provide for surface modification of polymers mesh, net or textile with improved properties. The methods of the present application further provide for loading of bioactive compounds of the modified-surface for improved release thereof, and polymers thus obtained.

Accordingly, the present application includes use of a modified-surface polymer produced by a method of the application, in agricultural applications.

Also provide is use of a modified-surface polymer produced by a method of the application, as a pheromonal pest control device.

Further included is use of a modified-surface polymer produced by a method of the application, as an exclusion nets.

Use of a modified-surface polymer produced by a method of the application, for repelling, disrupting feeding, confusing or inhibiting the mating of, knocking down, sterilizing or killing a target pest species, is also provided.

Further included is use of a polylactic acid mesh polymer having a modified-surface, a bioactive compound loaded on a modified-surface polymer, a semiochemical pest control device or an exclusion net of the present application, in agricultural applications.

Use of a polylactic acid mesh polymer having a modified-surface, a bioactive compound loaded on a modified-surface polymer, or the exclusion net of the application, as a semiochemical pest control device is also provided.

Also included is use of a polylactic acid mesh polymer having a modified-surface, a bioactive compound loaded on a modified-surface polymer, or a semiochemical pest control device of the application as an exclusion net.

Further provided is use of a polylactic acid mesh polymer having a modified-surface, a bioactive compound loaded on a modified-surface polymer, a semiochemical pest control device or an exclusion net of the present application, for repelling, disrupting feeding, confusing or inhibiting the mating of, knocking down, sterilizing or killing a target pest species.

### EXAMPLES

The following non-limiting examples are illustrative of the present application.

### General Methods

PLA mesh samples under the commercial name ‘Filbio®’ were purchased obtained from MDB Texinov (France). These meshes, with a pore size of 850 μm, were made by knitting multifilament fibres each 12 μm in diameter. Acetone and ethylene glycol (99% anhydrous) were used as received from Fisher Scientific and Sigma Aldrich, respectively. Deionized (DI) water was used directly from the university circuit (conductivity of 1 μS·cm⁻¹).

### Example 1—Initial Test on Slow Release of Pheromones

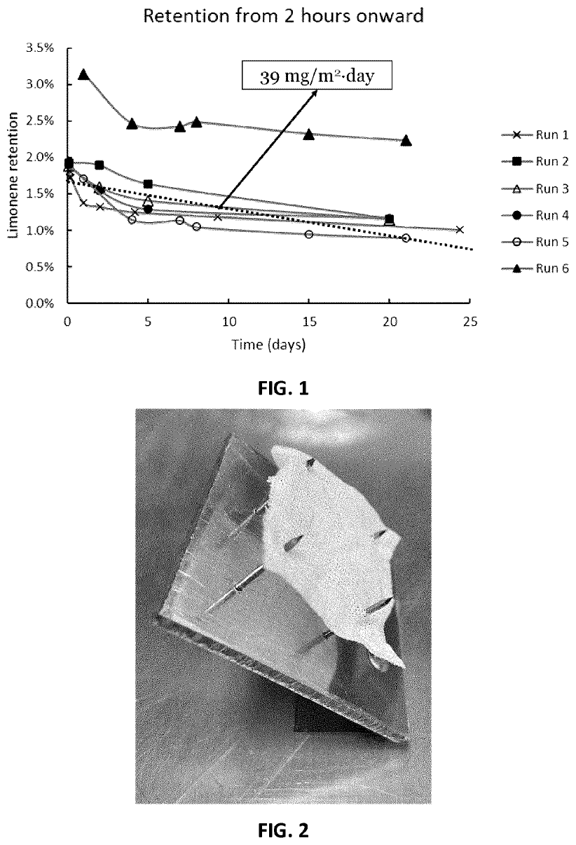

An initial set of 6 mass loss tests used as a proof of concept for the slow release of pheromone from modified polymer surfaces were conducted. These tests used the pheromone analogue limonene in place of an actual pheromone, but desorption properties for limonene are expected to be similar to real pheromones or other semiochemicals. Mass loss tests involved weighing the polymers periodically during desorption to measure the amount of adsorbed limonene that had been lost. The results for these tests are shown in FIG. 1 and the average rate of limonene loss is expressed in milligrams per day for each square meter of polymer surface area.

### Example 2—Surface Modification of PLA Mesh

The impact of three different surface treatment protocols on the developed surface microstructure was studied. A standard dip dip dry (DDD) method developed previously for 3D printed pure PLA sheets was used as the first protocol (Knoch, Chouinard et al. 2019). In this procedure, the PLA material is dipped in acetone for 10 minutes followed by dipping in DI water for 10 minutes, both at room temperature (RT). In the second protocol, the PLA mesh was treated in heated acetone at temperatures ranging from 35 to 43° C. for 2 minutes to 10 seconds respectively, followed by dipping it in water at room temperature for 2 minutes to 10 seconds correspondingly. A pre-treatment heating step was introduced in the third protocol by dipping the PLA mesh in heated ethylene glycol at 135° C. for 5 seconds followed by standard DDD treatment. After taking it out of water, the mesh was washed in DI water using magnetic stirrer at 500 rpm for 5 minutes to remove any residual ethylene glycol. After each of the above-mentioned protocols, the mesh was placed in a fume hood to dry for 12 hours. Hereafter, the surface treatments will be referred to by acronyms as given in Table 1.

TABLE 1
Surface modification protocols

| Protocol | Acronyms | Steps |
|---|---|---|
| Standard | Std DDD | 1. 10 min - in acetone (RT) |
| DDD | | 2. 10 min - in water (RT) |
| Heated | Δ acetone | 1. 2 min - in acetone (35° C.) |
| acetone | DDD | Up to 10s - in acetone (43° C.) |
| | | 2. 2 min to 10 s - in water (RT) |
| Heated | Δ EG std | 1. 5 s- in ethylene glycol (135° C.) |
| EG | DDD | 2. Steps 1&2 of std DDD |
| | | 3. 5 min - wash in DI water at 500 |
| | | rpm |

### Example 3—Surface Characterization of PLA Mesh

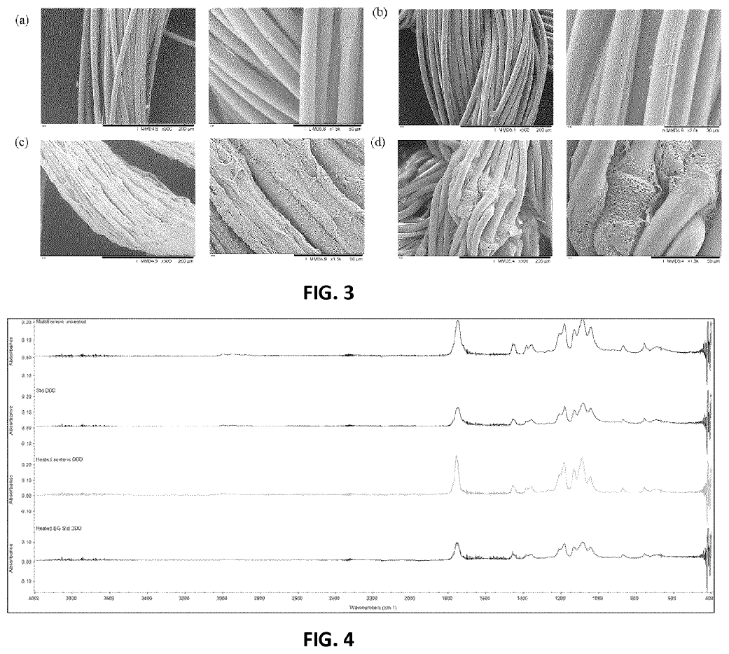

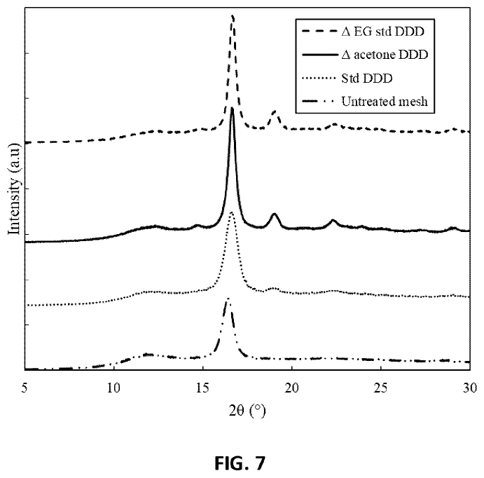

Scanning electron microscopy (SEM) (JSM7600F, JEOL, Japan) was conducted on the treated mesh to observe the surface topography of the fibres. Prior to imaging, a 25 nm thick coating of chromium was applied on the mesh samples using a sputter coater (model SC502, Fisons Instruments, UK, 30 s, 40 mm sample target distance, 16 W) to make them conductive (as shown in FIG. 3). To compare if the different protocols impacted the surface chemistry of the mesh, Fourier transform infrared spectroscopy (FTIR) (Nicolet iS5—ThermoScientific) was conducted (see FIG. 4). The analysis of change in crystallinity due to the thermal treatment was studied by differential scanning calorimetry DSC (DSC Q2000 TA instrument). The tests were conducted by four (4) alternate cycles of heating from room temperature to 200° C. at a rate of 10° C./min and then cooling down to room temperature at a rate of 10° C./min, under nitrogen atmosphere. Further, the variation in crystallinity of the mesh brought about by the surface modification was studied by X-ray diffraction (XRD) at room temperature on a Bruker D8 Advance DaVinci apparatus with a Cu source (kα1=1.54060). Each test was conducted with triplicate samples to ensure reproducibility. XRD data is shown in FIG. 6 and FIG. 7.

### Example 4—Mechanical Strength Test

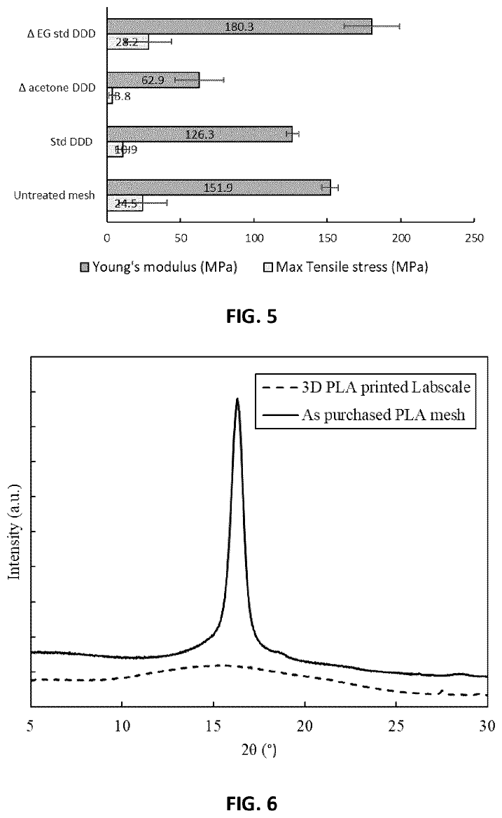

The effect of surface treatment of the mesh on its mechanical properties was tested using a Model 3365, Instron apparatus (USA). The meshes were placed in the weft direction for testing with a gauge length of 25 mm, with test speed of 167.5 mm/min and a pre-load of 1N. Each test was repeated in triplicate to confirm repeatability. Results are shown in FIG. 5.

### Example 5—Surface Wettability Assessment

A water drop test set up to measure the water retention and roll-off from the differently treated meshes. As shown in FIG. 2, the four stainless steel pins on the frame firmly holds the mesh sample. Water droplets were dispensed on to the mesh using a syringe pump at a rate of 1 mL/min. The water volume that rolled off the mesh and collected on the petri dish at the end of three minutes was measured using micropipette. The distance between the syringe pump and mesh was maintained at 20 cm and the holder was maintained at 45° inclination throughout all tests. Each experiment was triplicated to confirm repeatability.

In addition to assessing the wettability of the differently treated meshes, the durability of the wetting property of these mesh surfaces was also assessed by immersing 2 cm² sized samples in 10 ml beaker of DI water. The floatation of the meshes were assessed by visual inspection over a period of 60 days.

### Results

### Surface Characterization

FIG. 3 (a-d) shows the surface morphology of the untreated mesh, meshes treated by std DDD, Δ acetone DDD and Δ EG std DDD protocols, respectively. These SEM micrographs indicate that heated solvent treatments modified the surface morphology of the mesh fibres more visibly compared to the std DDD treatment. The Δ acetone DDD treatment transformed the fibre surface to be very porous, and coalescence of the fibres was observed. However, the Δ EG std DDD developed porous nodules on the fibres, still leaving the individual fibres free without merging.

From the FTIR results shown in FIG. 4, it was noted that the surface chemistry of all meshes remain unchanged from the original untreated mesh.

### Mechanical Strength

FIG. 5 illustrates that the maximum tensile strength of the std DDD treated sample is lower than that of the untreated mesh. A significant drop in both tensile strength and Young's modulus is observed for the samples treated by Δ acetone DDD, whereas the Δ EG std DDD approach did not exhibit this mechanical strength decrease—indeed, the tensile strength increased by 15%.

### Polymer Crystallinity

FIG. 6 indicates that the crystallinity of the commercial PLA is much higher, with a sharp peak at 16.2° (Bragg angle) compared to the almost amorphous lab scale PLA used in previous studies. Further, the crystallinity variation of the untreated mesh with the treated mesh samples was also analyzed. FIG. 7 shows the appearance of new peaks at 19.5 and 22.4° in addition to the characteristic peak at 16.2° in the case of DDD treated meshes. The additional peaks are prominent in the Δ acetone DDD and Δ EG std DDD treated meshes, where microstructure formation was also noted compared to std DDD protocol treated mesh as shown in FIG. 3. Without being bound by theory, the appearance of these multiple peaks only on the Δ EG std DDD and Δ acetone DDD mesh compared to the std DDD and untreated meshes would suggest that solvent induced recrystallisation occurred when heated solvents were employed.

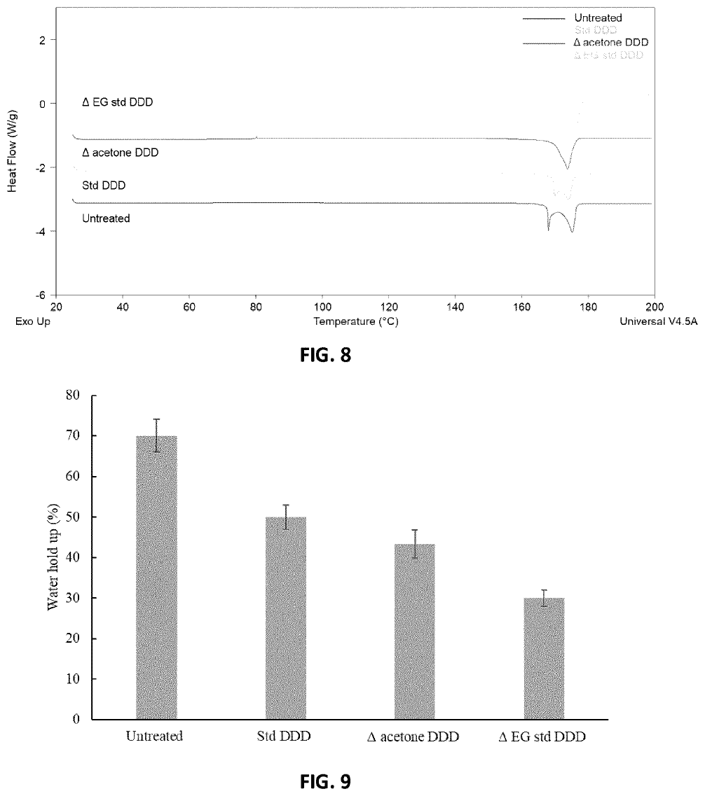

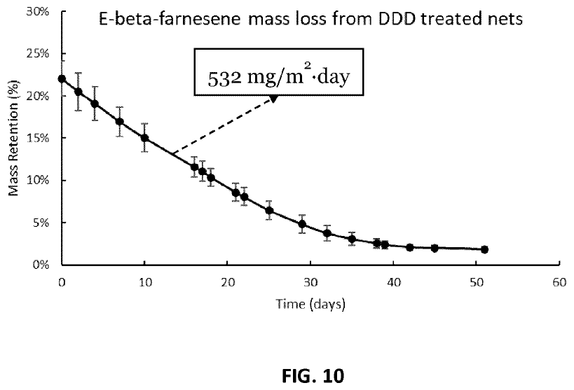

To understand the correlation of employing heated solvent and microstructure formation, differential scanning calorimetry (DSC) was conducted on the untreated and the differently DDD treated mesh samples. The results shown in FIG. 8 depicts the heating curve for 1st cycle of calorimetry testing. Without being bound to theory, it appears evident from the two melting peaks that the untreated mesh and mesh treated by Std DDD possess more than one crystal structure. However, the mesh that underwent treatment in Δ acetone and Δ EG shows one melting peak implying presence of a single crystal structure. Using equation (1), the crystallinity ratio value is calculated to be 57% for untreated, std DDD and Δ acetone treated meshes and 47% for the Δ EG treated mesh, using the value for melting enthalpy of pure 100% crystalline PLA as 93.1 J/g (Fischer, Sterzel et al. 1973, Domenek, Ducruet et al. 2016).

$$\% {X}_{c} = \frac{Δ {H}_{m} - Δ {H}_{c}}{93.1} * 100 \qquad ( 1 )$$

where ΔHₘ, ΔH_{c} are the melting and crystallisation enthalpies in J/g, respectively.

### Wettability

Videos were captured showing the capillary wicking nature of the untreated mesh and the hydrophobic nature of the different DDD treated meshes. To systematically assess the surface wettability of the different meshes, water drop testing results (FIG. 9) demonstrate that the water holds up on the mesh, i.e. water being retained by the mesh compared to water that rolls off the mesh, was as high as 57% on the untreated mesh and it reduced to 46%, 41% and 21% on the std DDD, Δ acetone DDD treated and Δ EG DDD treated mesh respectively.

When the mesh samples were dropped in a beaker containing DI water, the untreated mesh immediately adsorbed water and sank to the bottom. The std DDD treated mesh sample stayed afloat for less than an hour and then started imbibing water and sank. The Δ acetone DDD treated and Δ EG DDD continued to stay afloat after a period of 60 days, demonstrating the durability of the structures to prevent capillary condensation.

### Discussion

Previous studies reported dense microstructure formation on 3D printed PLA (prepared from pure PLA pellets on lab scale) following std DDD treatment (Knoch et al. 2019). However, when the same protocol is applied to the commercial PLA mesh, the surface morphology change occurred only on less than 5% of the total fibre surface area, as observed from the SEM images on FIG. 3.

Since the pre-requisite for solvent induced recrystallisation is that the polymer should be amorphous, the crystallinity of the lab scale and commercial PLA mesh was analyzed (Knoch et al. 2019). From XRD results shown in FIG. 4, it can be seen that the crystallinity of commercial PLA mesh is much higher than the lab scale 3D printed PLA mesh. The major difference between laboratory made 3D printed PLA and industrially manufactured PLA mesh is their manufacturing cycles. 3D printed PLA is made from virgin PLA filament and go through only one melting and solidifying cycle which preserves its amorphous nature (Knoch et al. 2019). However, PLA fibre manufacturing at commercial scale involves heating and cooling cycles along with drawing process at aspect ratios dependent on the fiber diameter required. Beyond geometry requirements, these cycles are also carefully optimized to reach the desired mechanical properties (e.g.: for exclusion netting used in agriculture). When higher drawing ratios are applied to prepare lower diameter fibres, this alters the crystallinity of the PLA material. From the studies of Fambri et. al., and without being bound to theory, it may be appreciated that for draw ratios higher than 3, the crystallinity of PLA increases for both melt and solution spun fibres (Fambri, Pegoretti et al. 1997, Auras, Lim et al. 2011). In addition, low molecular weight PLA (between 20 and 150 kDa) results in high crystalline material after the drawing process (Fambri, Pegoretti et al. 1997). In the case of the PLA fibres of the present application, the diameter is close to 12 μm, hence the application of a draw ratio higher than 4 is presumed. The molecular weight of the commercial PLA mesh was investigated by gel permeation chromatography and it was found that molecular weight is close to 20 kDa. Hence, without being bound to theory, it is submitted that since the commercial PLA mesh is crystalline, std DDD treatment was not efficient to create surface asperities that would alter wettability.

With this understanding, it was attempted to reduce the crystallinity of commercial mesh by heat treatment, without losing the shape and mechanical properties of the original mesh sample. In initial trials, the mesh was heated in air atmosphere in an oven at temperatures ranging from 70 to 150° C. When such heated mesh samples were quenched in acetone to conduct std DDD, no change in the surface morphology was noted, indicating ineffective thermal pre-treatment. Hence, the use of heated liquid media for better heat transfer with the mesh was selected. Systematic experiments were conducted by dipping the mesh samples in acetone heated from room temperature up to 40° C., by reducing the contact time with increase in temperature. The mesh sample from each experiment was inspected under the SEM to check for microstructure formation. It was noted that surface deformation and uniform morphology change over 80% of the mesh surface started occurring only above 38° C., but with increased contact time. However, this increased contact time n a high temperature solvent led to almost melting down of the mesh. Hence, the time/temperature setting was optimized to have the shortest time of contact to obtain uniform microstructure development on the fibre surface. The best setting was found to be acetone at 40° C., held for 30 seconds, followed by dipping in water at room temperature for 30 seconds to obtain uniform surface morphology as shown in the SEM micrograph in FIG. 3 (c).

Even though uniform microstructure formation was observed with the Δ acetone DDD treatment, it was also noted that it caused the individual fibres to coalesce into a single bundle. In addition, from the mechanical strength test results given in FIG. 5, it can be observed that the mechanical strength of Δ acetone DDD mesh was drastically reduced in comparison to the untreated mesh. Without being bound to theory, this could be the result of increased dissolution of PLA material into heated acetone. Since reduction of available surface area and mechanical strength are not desired conditions, shorter pre-heat treatment to modify the surface of PLA fibres were attempted.

Shorter pre-heat treatments were performed with higher solvent temperatures. Since the boiling point of acetone is nearly 55° C., ethylene glycol was used as it has a higher boiling point of 190° C. To find the optimized settings, different mesh samples were dipped in ethylene glycol for 5 seconds heated to temperatures from 60-150° C. and immediately quenched in room temperature acetone, to continue the std DDD protocol. After inspecting these meshes under the SEM, it was noted that the nodular porous surface structure as shown in FIG. 3 (d) formed only above 130° C. Further increasing the temperature above 135° C. caused the mesh to shrink significantly, to a point where it almost lost the mesh geometry. Hence the optimum settings of 135° C. for 5 seconds were retained for pre-heat treatment with ethylene glycol.

Since it was observed that the surface morphology was modified only on the mesh dipped in 40° C. acetone and 135° C. EG, its variation in crystallinity was investigated by DSC analysis. From the DSC results shown in FIG. 7, it can be seen that only one melting peak appear on the Δ acetone DDD and Δ EG std DDD treated mesh samples. It has been reported that the crystal structure transforms from α to β phase during the hot drawing process of PLA fibres (Hoogsteen, Postema et al. 1990, Takahashi, Sawai et al. 2004). Hence, without being bound to theory, it is assumed that the two melting peaks on the untreated mesh signify the presence of α and β crystals on the commercial mesh. The appearance of these same two melting peaks in the std DDD treated mesh indicates that no significant crystal alteration or deformation was induced by the solvent treatment. Since high crystallinity hinders the mobility of amorphous chains, we conclude this as the reason for poor surface modification by std DDD protocol (Auras, Lim et al. 2011). However, in the case of Δ acetone DDD and Δ EG std DDD treated meshes, the β-crystal melting peak is absent. Without being bound to theory, this could imply that either the β-crystals were destroyed or transformed to α-crystals. However, with the Δ EG std DDD treatment, the crystallinity ratio is lower (47%) compared with untreated and differently treated samples (57%), implying that the β-crystals were destroyed.

It can be seen from the FTIR data shown in FIG. 4 that almost no surface chemistry change occurred on the differently treated meshes in comparison with the commercial mesh. Hence, without being bound to theory, it is submitted that the variation in surface wettability can be attributed to the change in surface morphology as noted in the SEM images shown in FIG. 3. It was further noted that the extent of surface modification is significantly less in the case of std DDD treated mesh and that its hydrophobicity is not durable with time. When this mesh was left in contact with DI water in a beaker, it stayed afloat initially but with time (in less than 1 day) it started sinking, implying a transition in the wetting state from Cassie-Baxter to Wenzel.

The other two treatments with heated solvents render the mesh super hydrophobic with high durability. Both Δ acetone DDD and Δ EG std DDD mesh samples in contact with DI water continues to stay afloat even after 60 days. It was noted that the water-hold up on the Δ acetone DDD treated mesh is close to 40% and that on Δ EG std DDD mesh is nearly 20%. The SEM study suggests that in both these cases, surface morphology has drastically changed in comparison with the untreated mesh. The increased surface area with the porous microstructure enables higher water repellency in the case of these two mesh samples.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

### REFERENCES

Auras, R. A., L.-T. Lim, S. E. Selke and H. Tsuji (2011). Poly (lactic acid): synthesis, structures, properties, processing, and applications, John Wiley & Sons.
BASF. 2006. “Pheromone Worldwide Technical Brochure.” (September).
Blassioli-Moraes, M. C, R. A Laumann, M. F. F Micheref, and M. Borges. 2019. Semiochemicals for Integrated Pest Management. Springer, Cham.
Cui, Liang Liang et al. 2012. “The Functional Significance of E-β-Farnesene: Does It Influence the Populations of Aphid Natural Enemies in the Fields?” Biological Control 60(2): 108-12. http://dx.doi.org/10.1016/j.biocontrol.2011.11.006.
Domenek, S., V. J. B. Ducruet, b. p. f. environmental and b. applications (2016). “Characteristics and Applications of PLA.” 171-224.
Fambri, L., A. Pegoretti, R. Fenner, S. D. Incardona and C. Migliaresi (1997). “Biodegradable fibres of poly(l-lactic acid) produced by melt spinning.” Polymer 38(1): 79-85.
Fischer, E., H. J. Sterzel and G. J. K.-Z. u. Z. f. P. Wegner (1973). “Investigation of the structure of solution grown crystals of lactide copolymers by means of chemical reactions.” 251(11): 980-990.
Hercon Environmental. “Disrupt Bio-Dispenser DFB.”: 1-2. https://hercon.herculite.com/disruptants.
Ioriatti, Claudio, and Andrea Lucchi. 2016. “Semiochemical Strategies for Tortricid Moth Control in Apple Orchards and Vineyards in Italy.” Journal of Chemical Ecology 42(7): 571-83. http://dx.doi.org/10.1007/s10886-016-0722-y.
Knight, Alan L. 2002. “Development of Aerosol Devices for Management of Codling Moth and Leafrollers.” IOBC WPRS Bulletin 25(February).
Knoch, Simon, Gerald Chouinard, Marie Josee Dumont, and Jason R. Tavares. 2019. “Dip-Dip-Dry: Solvent-Induced Tuning of Polylactic Acid Surface Properties.” Colloids and Surfaces A: Physicochemical and Engineering Aspects 578(June): 123591. https://doi.org/10.1016/j.colsurfa.2019.123591.
Lucchi, Andrea et al. 2018. “Eco-Friendly Pheromone Dispensers—a Green Route to Manage the European Grapevine Moth?” Environmental Science and Pollution Research 25(10): 9426-42.
Mukherjee, Agneev et al. 2019. “Use of Bio-Based Polymers in Agricultural Exclusion Nets: A Perspective.” Biosystems Engineering 180:121-45.

Nakashima, Yoshitaka et al. 2016. “Field Evaluation of Synthetic Aphid Sex Pheromone in Enhancing Suppression of Aphid Abundance by Their Natural Enemies.” BioControl 61(5): 485-96.
Pacific Biocontrol. “ISOMATE LBAM Plus.” https://pacificbiocontrol.com/product/isomate-Ibam-plus/.
Pan, P., B. Zhu, W. Kai, T. Dong and Y. Inoue (2008). “Polymorphic Transition in Disordered Poly(l-lactide) Crystals Induced by Annealing at Elevated Temperatures.” Macromolecules 41(12): 4296-4304.
Sawai, D., K. Takahashi, A. Sasashige, T. Kanamoto and S.-H. Hyon (2003). “Preparation of Oriented β-Form Poly(l-lactic acid) by Solid-State Coextrusion: Effect of Extrusion Variables.” Macromolecules 36(10): 3601-3605.
Scentry Biologicals. “NoMate OLR Spiral.” http://scentry.com/pdf/NoMateOLRSpiral.pdf.
Sullivan, Brian T., Jeremy D. Allison, Richard A. Coyer, and William P. Shepherd. 2015. “Sex Pheromone of the Baldcypress Leafroller (Lepidoptera: Tortricidae).” Journal of Economic Entomology 108(1): 166-72.
Suterra LLC. 2019. “CheckMate VMB_XL.” https://www.suterra.com/products/vmb-xl.
Takahashi, K., D. Sawai, T. Yokoyama, T. Kanamoto and S.-H. Hyon (2004). “Crystal transformation from the α- to the β-form upon tensile drawing of poly(l-lactic acid).” Polymer 45(14): 4969-4976.
Tomaszewska, Elizabeth et al. 2005. “Evaluation of Pheromone Release from Commercial Mating Disruption Dispensers.” Journal of Agricultural and Food Chemistry 53(7): 2399-2405.
Trécé. 2016. “CIDETRAK CM.” 2. https://www.trece.com/products/cidetrak-cm-codling-moth/.
Vosteen, Ilka, Wolfgang W. Weisser, and Grit Kunert. 2016. “Is There Any Evidence That Aphid Alarm Pheromones Work as Prey and Host Finding Kairomones for Natural Enemies?” Ecological Entomology 41 (1): 1-12.
Zhang, J., K. Tashiro, H. Tsuji and A. J. Domb (2007). “Investigation of Phase Transitional Behavior of Poly(l-lactide)/Poly(d-lactide) Blend Used to Prepare the Highly-Oriented Stereocomplex.” Macromolecules 40(4): 1049-1054.

1. A method for modifying a wettability of a surface of a polymer mesh, net or textile, the method comprising:
subjecting the polymer mesh, net or textile to a treatment in a solvent; and
subjecting the resulting polymer to a treatment in a coagulant to provide the polymer with the surface having modified wettability;
and further comprising a pre-heating treatment in a heated liquid media.

2-3. (canceled)

4. A method for producing a semiochemical pest control device, the method comprising:
subjecting a polymer mesh, net or textile to a treatment in a solvent;
subjecting the resulting polymer to a treatment in a coagulant to provide the modified-surface polymer; and
loading at least one insect semiochemical on the modified-surface polymer mesh, net or textile by physisorption to provide the semiochemical pest control device.

5-7. (canceled)

8. The method of claim 1, wherein the polymer is an amorphous polymer or a surface-amorphous polymer.

9. The method of claim 1, wherein the polymer is a semi-crystalline polymer or a crystalline polymer.

10. (canceled)

11. The method of claim 1, wherein the polymer is selected from a polylactic acid polymer, nylon, a polycarbonate polymer, a polyethylene polymer, and mixtures thereof.

12. The method of claim 1, wherein the solvent is selected from acetone, ethyl acetate, ethanol, acetonitrile, ionic liquids and mixtures thereof.

13. The method of claim 1, wherein the solvent is a solvent with a Relative Energy Distance (RED) between about 0.4 and about 1.0 as determined through Hansen solubility parameters.

14. The method of claim 1, wherein the coagulant is selected from water, methanol, ethanol, ethylene glycol and mixtures thereof.

15. The method of claim 1, wherein the treatment in the solvent comprises dipping in the solvent for about 0.5 second to about 30 minutes.

16-17. (canceled)

18. The method of claim 1, wherein the treatment in the coagulant comprises dipping in the solvent for about 0.5 second to about 30 minutes.

19-21. (canceled)

22. The method of claim 1, wherein the liquid media is heated at a temperature of about 30° C. to about 150° C. above the glass transition temperature of the polymer.

23-24. (canceled)

25. The method of claim 1, wherein the pre-heating treatment comprises dipping in the heated liquid media for about 0.2 second to about 10 minutes.

26-27. (canceled)

28. The method of claim 1, wherein the liquid media is selected from ethylene glycol, acetone, mineral oil, vegetable oil, a solvent having a boiling point about 40° C. to about 100° C. above the glass transition temperature of the polymer and mixtures thereof.

29. (canceled)

30. The method of claim 1, wherein the repellent is selected from limonene, carvone, myrcene and combinations thereof.

31. The method of claim 1, wherein the semiochemicals are intraspecific or interspecific semiochemicals.

32. The method of claim 31, wherein the intraspecific semiochemicals are pheromones.

33. The method of claim 31, wherein the interspecific semiochemicals are selected from allomones, kairomones, synomones, antimones, necromones, and mixtures thereof.

34-38. (canceled)

39. The method of claim 1, wherein the bioactive compound and/or semiochemical is released from the modified-surface polymer over about 10 days to about 90 days.

40-41. (canceled)

42. The method of claim 1, wherein the bio-active compound and/or semiochemical is released from the modified-surface polymer at a release rate from about 5 mg/m² per day to about 500 mg/m² per day.

43-45. (canceled)

46. The method of claim 1, wherein the loading of the bioactive and/or semichemical further comprises an antioxidant and/or a polymerization inhibitor.

47-113. (canceled)
